(19) United States
(12) Patent Application Publication
(10) Pub. No.: US 2016/0306730 A1
(43) Pub. Date: Oct. 20, 2016

(54) Projection of software and integrated circuit diagrams into actual 3D space

(71) Applicant: Richard Stanley Fencel, Irvine, CA (US)

(72) Inventor: Richard Stanley Fencel, Irvine, CA (US)

(21) Appl. No.: 15/157,252

(22) Filed: May 17, 2016

Related U.S. Application Data
(63) Continuation-in-part of application No. 14/133,059, filed on Dec. 18, 2013, now Pat. No. 9,383,975.
(60) Provisional application No. 61/849,447, filed on Jan. 28, 2013.

(51) Int. Cl. G06F 11/36; G06T 15/08; G06T 19/00; G06F 17/50

(52) U.S. Cl. CPC G06F 11/362; G06F 17/5077; G06T 15/08; G06T 19/006

(57) ABSTRACT

Embodiments of the present invention include apparatus, method, and program product for displaying in actual 3D space (i.e. not merely a 3D representation on a 2D surface) any type of diagram relating to software or integrated circuits that requires depth perception in order to be fully comprehended. The 3D space can be manipulated as desired, including but not limited to rotation, collapse/expand, and the ability of the user to enter the 3D space and view it from within the 3D space.

### CROSS REFERENCE TO RELATED APPLICATIONS

This application is a continuation-in-part of U.S. patent application Ser. No. 14/133,059 filed 18 Dec. 2013, now U.S. Pat. No. ______, which claims priority from U.S. Patent Application No. 61/849,447 filed 28 Jan. 2013, the contents of these applications are hereby expressly incorporated by reference thereto in their entireties for all purposes.

### FIELD OF THE INVENTION

The present invention relates generally to the projection of any kind of software or integrated circuit diagram into three-dimensional (3D) space allowing for clearer understanding of all details, such as, for example, an efficient debug display of a software program state at a given time for a clearer understanding of an operation state of a program.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Current 3D display of software diagrams is done using perspective drawing techniques on a two dimensional (2D) surface. An example is an exploded list of software objects (such as a table of database records). The main limitation of this approach is that each software object (e.g., database record) may be connected to additional objects (e.g. other database records) which may in turn have further connections ad infinitum (as in an object-oriented database). These complex orthogonal relationships are hard to depict on a 2D surface, making it difficult to visualize the operation of the entire system.

Similarly, 3D displays of integrated circuits also use perspective drawing techniques on a 2D surface. An example is a multi-layered integrated circuit. A limitation of this approach is analogous to that of software diagrams, namely that complex orthogonal relationships are hard to depict on a 2D surface.

What is needed is a system, method, and computer program product for depicting complex multi-dimensional relationships.

### BRIEF SUMMARY OF THE INVENTION

Disclosed is a system, method, and computer program product for depicting complex multi-dimensional relationships.

The following summary of the invention is provided to facilitate an understanding of some of the technical features related to actual three dimensional projection, and is not intended to be a full description of the present invention. A full appreciation of the various aspects of the invention can be gained by taking the entire specification, claims, drawings, and abstract as a whole. The present invention is applicable to other models in addition to efficient debug.

In view of disadvantages inherent in the known two dimensional types of display of software and integrated circuit diagrams, embodiments of the present invention may provide a full depth 3D experience for such diagrams. The 3D effect can be created using stereoscopy (with or without 3D glasses), holograms, or any technique that projects an image into actual 3D space or any kind of virtual reality.

In view of disadvantages inherent in the known types of 2D debug displays, an embodiment of the present invention may include a manner of projecting into actual 3D space the conventional watch window and conventional memory snapshot.

An embodiment of the present invention may add to the memory snapshot an ability to dynamically display memory objects as they are created, changed, and destroyed.

An embodiment of the present invention may also provide an analysis tool for simplifying memory design by analyzing the connections among objects in memory.

An embodiment of the present invention may provide a way to combine the conventional watch window and memory snapshot into one window projected into actual 3D space.

A computer-implemented method for a three-dimensional projection of a set of objects onto a display supporting multiple depths, each object including an X axis, a Y axis, and a Z axis, including a) presenting a first subset of objects on the display at a first particular display depth, a functional object in the first subset of objects including a mapping element wherein the first subset of objects is selected from the set of objects; b) detecting a user selection of the mapping element triggering a projection event; and c) presenting, responsive to the projection event, a second subset of objects on the display at a second particular display depth different from the first particular display depth; wherein the three-dimensional projection includes a data model including the set of objects, the data model including a set of predetermined relationships between the first subset of objects and the second subset of objects wherein one or more relationships of the set of predetermined relationships are visualized by the presenting step c); and wherein the second subset of objects is selected from the set of objects; wherein the data model includes a watch window that is displayed whenever a breakpoint is reached.

The watch window may display selected variables that are in scope, and in some cases the watch window displays selected objects and associated variables. Reference type variables may trigger a second set of objects which may in turn display a new set of reference variables in a nested manner.

A computer-implemented method for a three-dimensional projection of a set of objects onto a display supporting multiple depths, each object including an X axis, a Y axis, and a Z axis, including a) presenting a first subset of objects on the display at a first particular display depth, a functional object in the first subset of objects including a mapping element wherein the first subset of objects is selected from the set of objects; b) detecting a user selection of the mapping element triggering a projection event; and c) presenting, responsive to the projection event, a second subset of objects on the display at a second particular display depth different from the first particular display depth; wherein the three-dimensional projection includes a data model including the set of objects, the data model including a set of predetermined relationships between the first subset of objects and the second subset of objects wherein one or more relationships of the set of predetermined relationships are visualized by the presenting step c); and wherein the second subset of objects is selected from the set of objects; and wherein the data model includes a memory snapshot diagram that displays selected objects and a set of memory reference connections amongst the selected objects.

In some embodiments, the memory snapshot uses visual effects to indicate modifications in the memory layout between any two points in time. The modifications thus displayed can be either created, destroyed, or changed objects or any combination thereof. The memory snapshot diagram optionally may also display the associated reference variables belonging to the objects.

A computer-implemented method for a three-dimensional projection of a set of objects onto a display supporting multiple depths, each object including an X axis, a Y axis, and a Z axis, including a) presenting a first subset of objects on the display at a first particular display depth, a functional object in the first subset of objects including a mapping element wherein the first subset of objects is selected from the set of objects; b) detecting a user selection of the mapping element triggering a projection event; and c) presenting, responsive to the projection event, a second subset of objects on the display at a second particular display depth different from the first particular display depth: wherein the second subset of objects is selected from the set of objects; wherein the model includes a watch window that is displayed whenever a breakpoint is reached during program execution or a method in a call stack up to the breakpoint; and/or wherein the model includes a memory snapshot diagram that displays selected objects and the associated reference variables and memory reference connections. This may include, but is not limited to enabling, at any time during program execution, whether at a breakpoint, call stack method or while execution is in progress, the display of variables of any object whether the object is in scope not, as well as the memory connections between objects.

A non-transitory computer-readable medium for a three-dimensional projection of a set of objects onto a display supporting multiple depths, each object including an X axis, a Y axis, and a Z axis, comprising instructions stored thereon, that when executed on at least one processor, perform the steps of: a) presenting a first subset of objects on the display at a first particular display depth, a functional object in the first subset of objects including a mapping element wherein the first subset of objects is selected from the set of objects; b) detecting a user selection of the mapping element triggering a projection event; and c) presenting, responsive to the projection event, a second subset of objects on the display at a second particular display depth different from the first particular display depth; wherein the three-dimensional projection includes a data model including the set of objects, the data model including a set of predetermined relationships between the first subset of objects and the second subset of objects wherein one or more relationships of the set of predetermined relationships are visualized by the presenting step c); and wherein the second subset of objects is selected from the set of objects; and wherein said data model includes a memory snapshot diagram that displays selected objects and a set of memory reference connections amongst said selected objects.

Any of the embodiments described herein may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates projection of a software diagram into actual 3D space;

FIG. 2 illustrates a detailed view of sample 3D software diagram;

FIG. 3 illustrates a detailed view of a sample 3D integrated circuit diagram;

FIG. 4 illustrates a portion of a computer program that demonstrates a use of reference variables to create objects in a memory;

FIG. 5 illustrates the computer program of FIG. 4 modified so that one of the objects has multiple memory references;

FIG. 6 illustrates a conventional watch window based on an execution of the computer program in FIG. 4;

FIG. 7 illustrates a conventional watch window based on the execution of the computer program in FIG. 5;

FIG. 8 illustrates a conventional memory snapshot based on the execution of the computer program in FIG. 4;

FIG. 9 illustrates a conventional memory snapshot based on the execution of the computer program in FIG. 2;

FIG. 10 illustrates a watch window based on the execution of the computer program in FIG. 4 and using an embodiment of the present invention wherein the watch window is projected into actual 3D space;

FIG. 11 illustrates a watch window based on the execution of the computer program in FIG. 5 and using an embodiment of the present invention wherein the watch window is projected into actual 3D space;

FIG. 12 illustrates a memory snapshot based on the execution of the computer program in FIG. 4 and using an embodiment of the present invention wherein the memory snapshot is projected into actual 3D space; and

FIG. 13 illustrates a memory snapshot based on the execution of the computer program of FIG. 5 and using and embodiment of the present invention wherein the memory snapshot is projected into actual 3D space.

### DETAILED DESCRIPTION OF THE INVENTION

Embodiments of the present invention provide a system, method, and computer program product for depicting complex multi-dimensional relationships. The following description is presented to enable one of ordinary skill in the art to make and use the invention and is provided in the context of a patent application and its requirements.

Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

### DEFINITIONS

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The following definitions apply to some of the aspects described with respect to some embodiments of the invention. These definitions may likewise be expanded upon herein.

As used herein, the term “or” includes “and/or” and the term “and/or” includes any and all combinations of one or more of the associated listed items. Expressions such as “at least one of,” when preceding a list of elements, modify the entire list of elements and do not modify the individual elements of the list.

As used herein, the singular terms “a,” “an,” and “the” include plural referents unless the context clearly dictates otherwise. Thus, for example, reference to an object can include multiple objects unless the context clearly dictates otherwise.

Also, as used in the description herein and throughout the claims that follow, the meaning of “in” includes “in” and “on” unless the context clearly dictates otherwise. It will be understood that when an element is referred to as being “on” another element, it can be directly on the other element or intervening elements may be present therebetween. In contrast, when an element is referred to as being “directly on” another element, there are no intervening elements present.

As used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

As used herein, the term “adjacent” refers to being near or adjoining. Adjacent objects can be spaced apart from one another or can be in actual or direct contact with one another. In some instances, adjacent objects can be coupled to one another or can be formed integrally with one another.

As used herein, the terms “connect,” “connected,” and “connecting” refer to a direct attachment or link. Connected objects have no or no substantial intermediary object or set of objects, as the context indicates.

As used herein, the terms “couple,” “coupled,” and “coupling” refer to an operational connection or linking. Coupled objects can be directly connected to one another or can be indirectly connected to one another, such as via an intermediary set of objects.

The use of the term “about” applies to all numeric values, whether or not explicitly indicated. This term generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%.

As used herein, the terms “substantially” and “substantial” refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

As used herein, the terms “optional” and “optionally” mean that the subsequently described event or circumstance may or may not occur and that the description includes instances where the event or circumstance occurs and instances in which it does not.

3D Software Diagrams

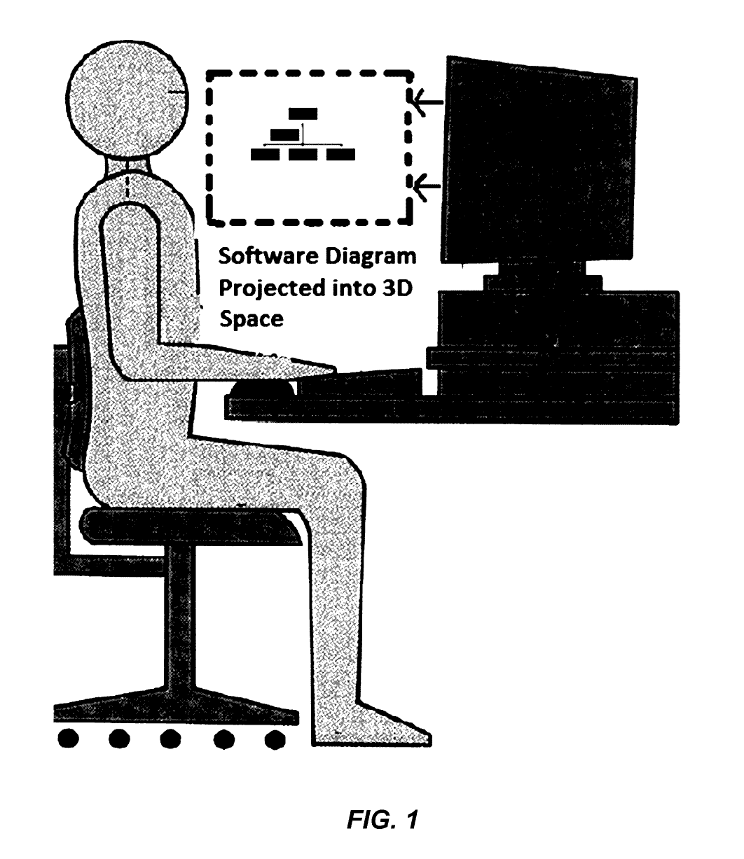

FIG. 1 illustrates a system using stereoscopy for projecting software diagrams into actual 3D space as opposed to merely drawing a 3D perspective onto a 2D surface. In FIG. 1, the 3D projection is achieved using stereoscopy but could also be achieved with holograms or any other technique that projects an image into actual 3D space. The user may or may not be required to wear 3D glasses depending on the mechanism that implements the 3D effect.

The software diagrams that are most effectively displayed using the present invention are inherently three-dimensional, i.e. information is conveyed using a vertical Z-Axis as well as the horizontal X and Y axes.

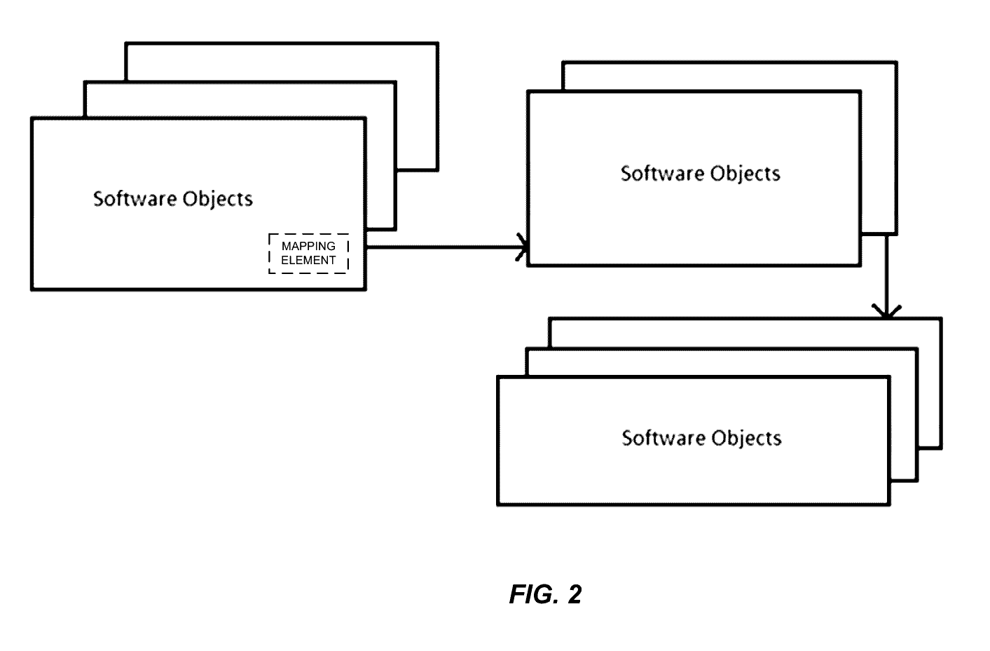

FIG. 2 is an example of such a 3D software diagram. FIG. 2 is an abstract representation of objects (for example, functional objects) that map to a series of other objects in response to an operation of a mapping element and each of the objects in the mapped-to series can in turn map to an additional series of objects. Specific examples include (1) an object-oriented database, i.e. a database where each record in a table points to a table of other records each of which may point to additional tables; and (2) lists of objects currently in memory and their interrelationships. An embodiment of the present invention may project this diagram into actual 3D space.

A second type of 3D software diagram well-suited to some embodiments of the present invention may be one that illustrates the execution of a “parallel programming” application. The diagram would display, for example, the operation of concurrent processes, threads, and tasks as well as communications between them.

A third type of 3D software diagram well-suited to some embodiments of the present invention may use time as the third dimension. An example would be a display of variable values in a recursive function during successive calls of the function.

In general, all software diagrams where depth is important can benefit from being projected into actual 3D space using the present invention.

All of the software components in a 3D projection do not need to be displayed at once. The various components can be either not shown at all or shown collapsed with the ability to be expanded as desired, such as with a functional object selectively operated by a user. An example would be the opening of a table of database records. Some embodiments of the present invention may allow complete “drill down” capability to allow the user to zero in on those components of interest that may be nested many layers down.

The 3D display can also be rotated to allow it to be viewed from any angle.

The user can also “enter” the display so that they visualize the software object relationships from the inside. That is, the user can “wander” throughout the structures as if they were inside a building or other multidimensional structure. This effect may or may not require 3D glasses.

The above techniques of display manipulation are not the only ones possible but serve as an illustration.

As an application executes, the 3D display may change in real-time in order to reflect changes in the application's state. For example, in an object-oriented data base, the user may be enabled to watch software objects as they get populated using both eager and lazy loading. It would also be possible to view intermediate results of certain operations such as nested joins in a database query. Viewing dynamically the internal workings in 3D, especially from within, may, in some embodiments, help reveal bottlenecks and other design flaws. These are some but not all the real-time viewing scenarios that are possible.

In some implementations, there may also exist a “2D” mode where all the above features are available but are instead shown on a 2D surface with all the limitations of a 2D display.

3D Integrated Circuit Diagrams

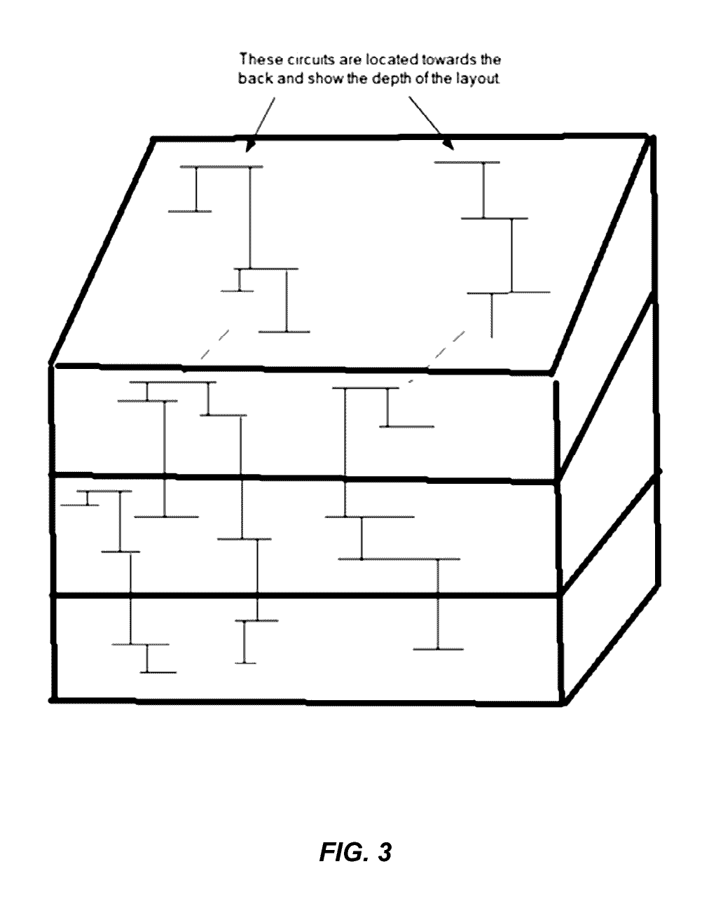

FIG. 3 is an example of a 3D diagram for integrated circuits. An embodiment of the present invention may project this diagram into actual 3D space, allowing all the circuitry with its vertical and horizontal interconnects to be viewed without the obfuscation of 2D perspective and in some implementations some information or relationships may be dynamically updated.

This projection would be analogous to the projection of software diagrams. That is, the projection could be implemented with stereoscopy as shown in FIG. 1 or be achieved with holograms or any other technique that projects an image into actual 3D space. The user may or may not be required to wear 3D glasses depending on the mechanism that implements the 3D effect.

Just as in the 3D software diagrams, all the components of the 3D integrated circuit do not need to be displayed at once. In some embodiments of the present invention it may be possible to collapse certain components and then “drill down” to those of interest.

Also like the 3D projection of software diagrams, the 3D diagram can be rotated or viewed from any angle. The diagram, in this case the integrated circuit, can also be “entered”, allowing the user to wander throughout its structure allow the user to detect design flaws or other features.

The above techniques of display manipulation are not the only ones possible but serve as an illustration.

It would also be possible to simulate the execution of the integrated circuit, showing the voltages at various nodes and times depending on location, lead lengths, etc. Viewing the internal workings in real 3D would allow the user to optimize the design.

For some embodiments, there may also exist a “2D” mode where all the above features are available but are instead shown on a 2D surface with all the limitations of a 2D display.

Other Kinds of 3D Design

The above described approach to using 3D projection could also be applied to many different forms of design, such as aircraft, automobiles, ships, hand tools, and the like.

Debug Display

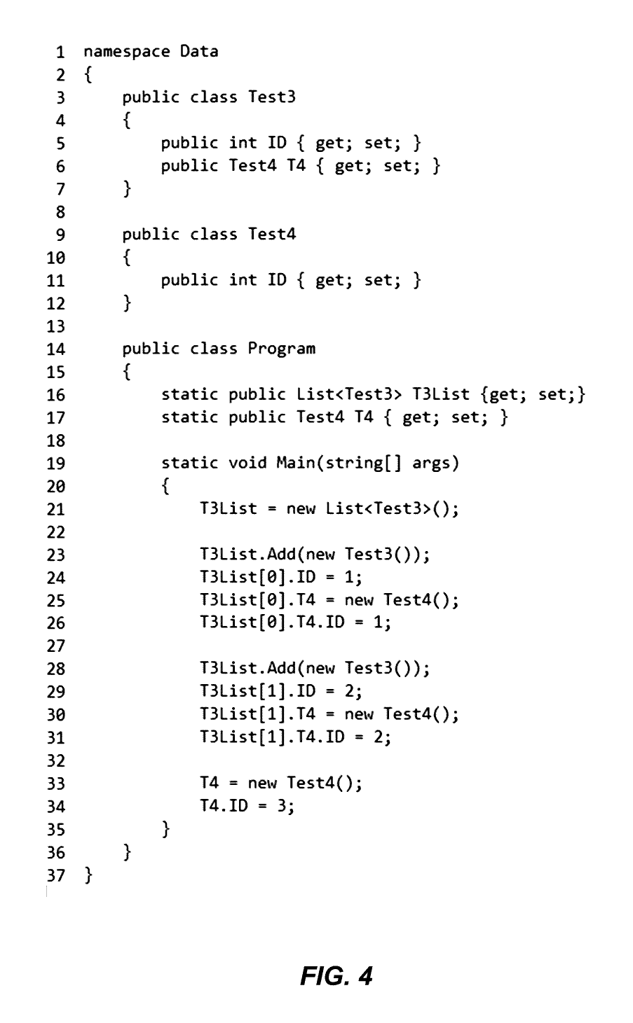

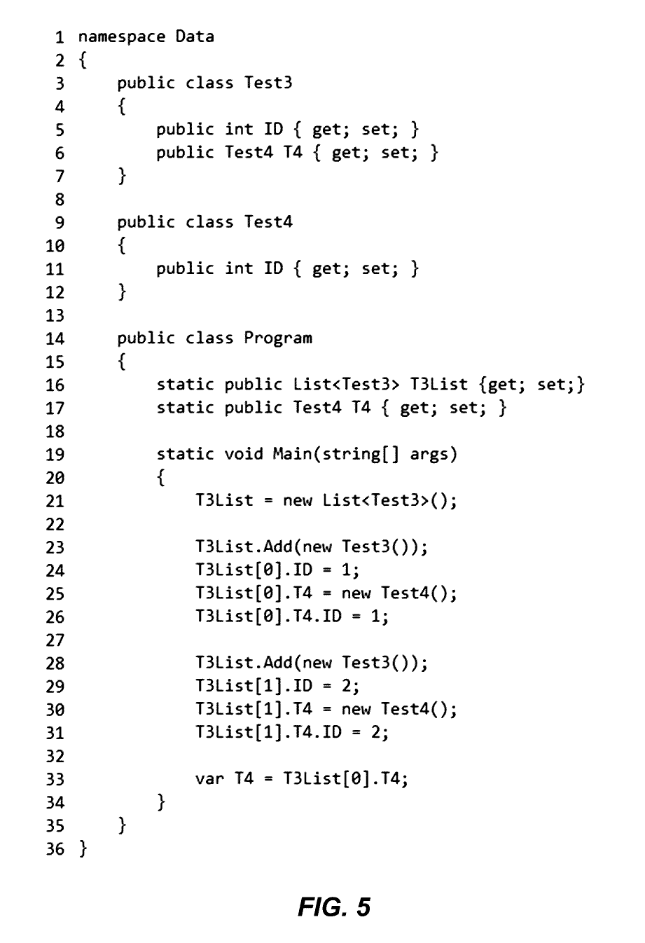

The current technique that is used to inspect program variables during debug is to set a breakpoint that causes program execution to pause when the breakpoint is encountered. At that time, the user can then manually click on a variable in the source code where the breakpoint occurred and if the object to which the variable belongs is in scope, then the variable's value will be displayed. A variable's value can be either a scalar, such as an integer, or a reference to another object that can have its own reference variables that can in turn refer to more objects, ad infinitum. A reference variable in an object can thus expand in a tree-structured manner to refer to a large number of objects. An example of a portion of a computer program that creates such variables is illustrated FIG. 4. Note that in this program all memory objects are singly referenced. The computer program of FIG. 4 may be modified to create an object that has multiple references. An example of such a computer program is illustrated in FIG. 5. Lines 33 and 34 have been replaced with a program statement that creates a second reference to an object of type Test4.

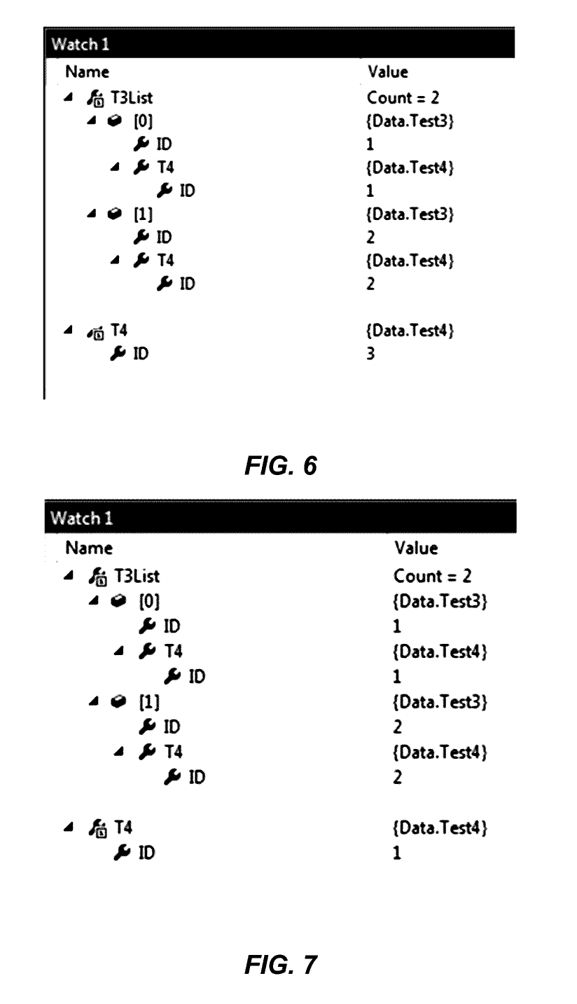

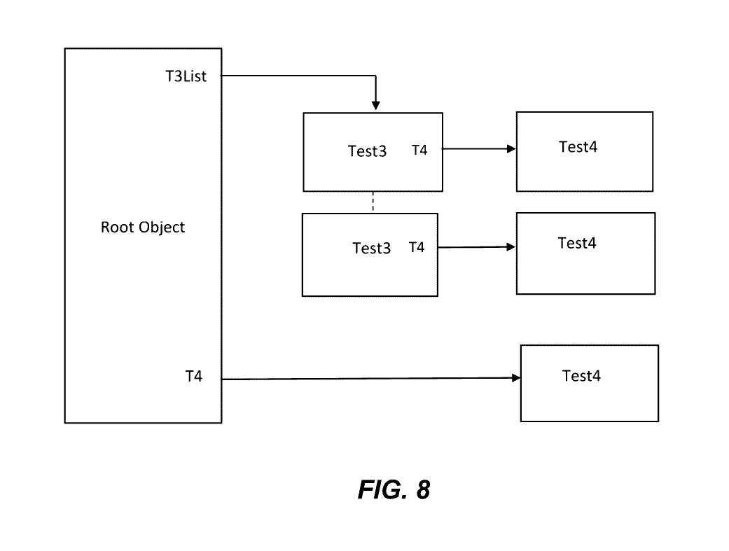

When a variable will be repeatedly examined, it can be added to a separate “watch window” where its most recent value, either scalar or reference, automatically appears whenever the program again reaches the same breakpoint. Multiple variables can be added to the watch window. Variables having values that have changed may be displayed in a different color. The watch window thus described is easy to depict in 2D space. A watch window is illustrated in FIG. 6. This is the watch window that could be created if a breakpoint were inserted on the last line of the computer program in FIG. 4. The watch window shown in FIG. 7 could be created if the breakpoint were inserted on the last line of the computer program in FIG. 5. Notice how in FIG. 7, the ID property of the Test4 object referenced by the watch window property T4 is 1 and not 3 as it was in FIG. 6. The value of the ID property of the Test4 object referenced by T3List[0].T4 is also 1. The ID's are the same because both properties reference the same Test4 object. This is a difference between FIG. 6 and FIG. 7. Notice how in FIG. 7, the ID property of the Test4 object referenced T4 shown in the watch window is the same as the ID property of the Test4 object referenced by T3List[0].T4. This is because they both reference the same Test4 object.

A breakpoint is also accompanied by a stack trace of all methods executed up to the breakpoint. By clicking on any method in the stack trace, it is possible to inspect the current value of variables that are in scope at that time. These variables can also be added to the watch window which will display their values when they are in scope.

An understanding of how memory is allocated and referenced can be achieved through the use of a commonly available memory profiler utility. The memory profiler creates a “memory snapshot” diagram that may show selected objects currently in memory and how they refer to one another via reference variables. A watch window such as those described above, which display a tree-structured list objects in memory and their reference variables, also performs this function but in a limited manner. A memory snapshot generated by a memory profiler typically has the following differences: (1) a memory snapshot can be created anytime during program execution, not just at a breakpoint or a method in a call stack leading up to a breakpoint; (2) There is no concept of “scope”, i.e. objects anywhere in memory can be displayed; (3) Only reference values and the objects they point to are typically displayed; (4) A memory profiler can typically limit the objects displayed to an entire class of objects (a watch window can limit the objects delayed only to specific objects in scope); (5) if an object is referred to by multiple objects, then a direct connection is shown for all references. This last feature, showing all connections for multiple references to an object, causes drawing overlap issues, i.e. the drawing of memory reference connections results in intersections and detours around drawing elements. The overlap is exacerbated by the multi-layered nature of object arrays. A memory snapshot is thus difficult to depict on a 2D surface and for this reason, memory snapshots are usually limited to a small subset of all objects in memory. The overlap problem could be partially alleviated by the use of 3D perspective drawings that could be expanded and rotated but there remain intrinsic limitations of trying to project a 3D system into 2D space.

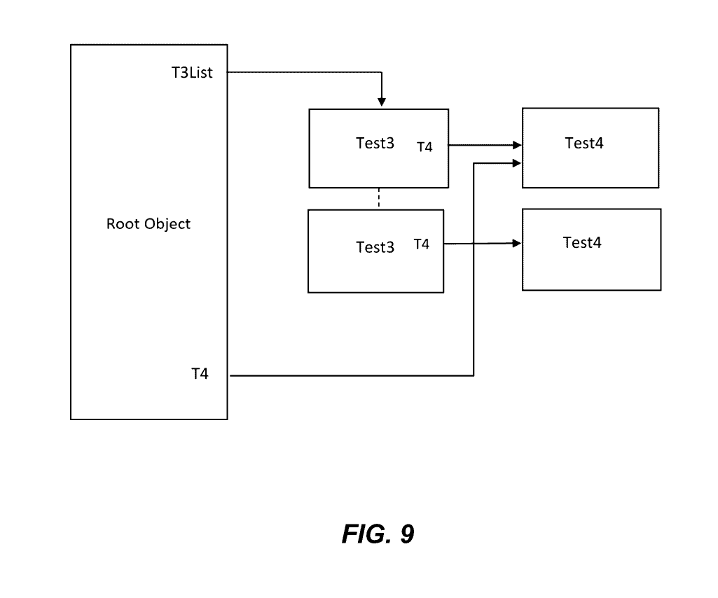

FIG. 8 illustrates a memory snapshot of a memory layout that has only single memory references to any object. This is the layout that would be shown if a memory snapshot were made at the end of the program in FIG. 4. A memory snapshot that shows an object that has multiple references is shown in FIG. 9. This is the layout that would be shown if a memory snapshot were made at the end of the program in FIG. 5.

An embodiment of the present invention may include three components: (1) a 3D watch window (2) a 3D memory profiler (3) and an advanced 3D debug window that combines the aforementioned 3D watch window and 3D memory profiler.

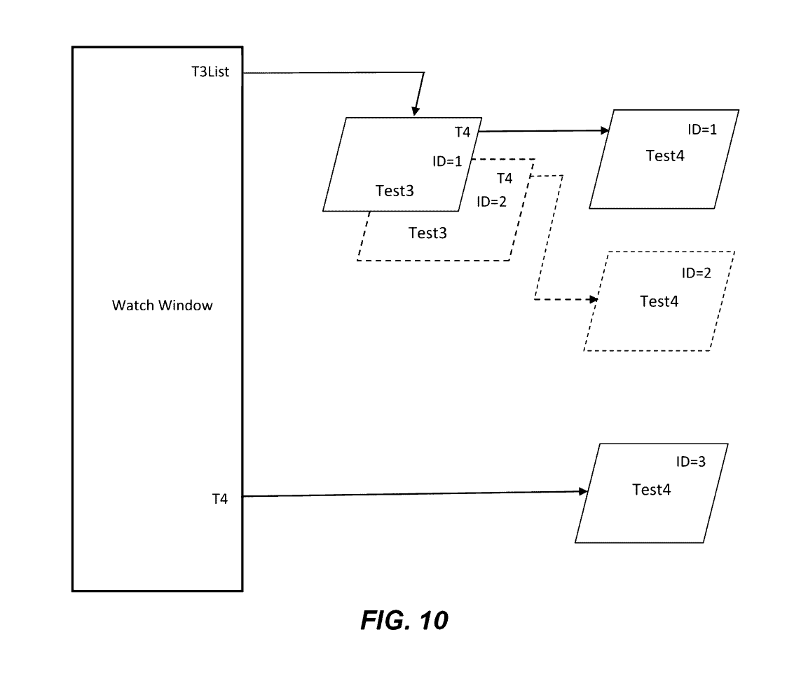

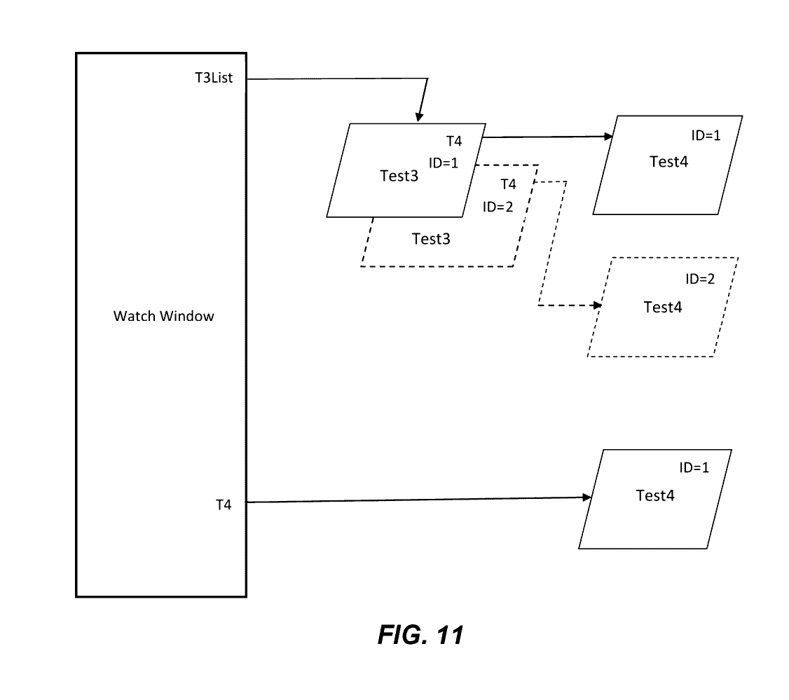

The 3D watch window is similar to the watch window described herein. Scalar or reference variables can, when they are in scope, be examined at a breakpoint or call stack method. Reference variables are shown in a tree-structured manner. Variables who values have changed can be displayed in a different color. One difference available to some embodiments of the present embodiment is that the watch window diagram is projected into actual 3D space. The 3D watch windows that are illustrated in FIG. 10 and FIG. 11 are based on the programs of FIG. 4 and FIG. 5 and are analogous to the watch windows in FIG. 6 and FIG. 7. FIG. 10 illustrates a 3D watch window that would be shown at a breakpoint at the end of the program in FIG. 4. FIG. 11 illustrates a 3D watch window that would be shown at a breakpoint at the end of the program in FIG. 5. Note that in FIG. 11, the ID of the Test4 object referenced by the property T4 shown in the watch window is 1 and not 3 as it is in F. This is because in FIG. 11, the object referenced by property T3List[0].T4 and by the T4 property shown in the watch window is the same. This is a difference between FIG. 10 and FIG. 11. Also note that in both FIG. 10 and FIG. 11, objects and connections that are displayed at a lower Z-order in the 3D space are shown with dashed lines.

The 3D memory profiler may be similar to the memory profiler described herein. A conventional memory snapshot can be made at any time, and any object currently in memory can be displayed, connections to multiple references to the same object are shown, and reference variables can optionally be shown. A difference available in some embodiments of the present invention is that the memory snapshot is projected into actual 3D space. Due to the depth of the 3D projection, drawing overlap may be reduced. The 3D display may be expanded and rotated to make the memory layout more discernible. Selection and operation of functional elements, such as mapping elements, may be used to expand or contract windows.

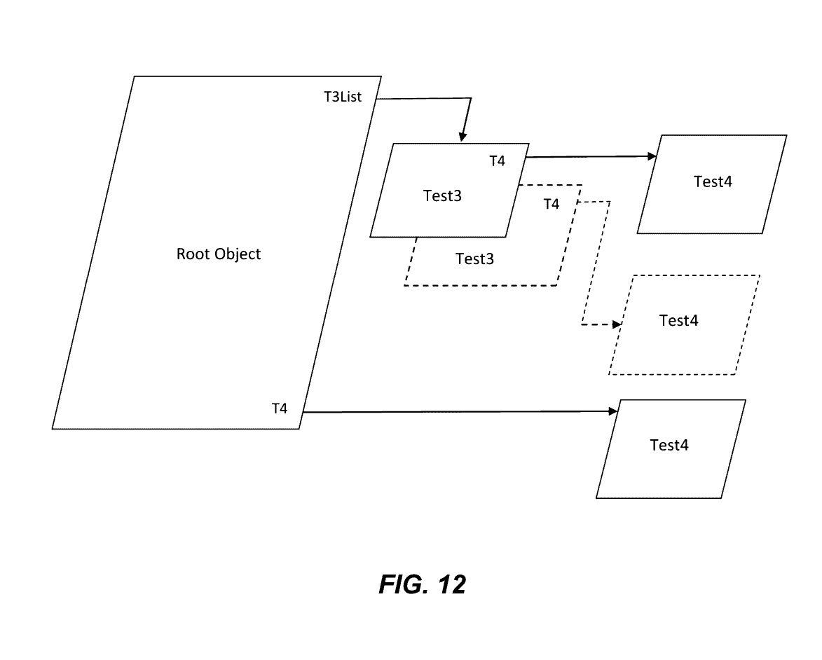

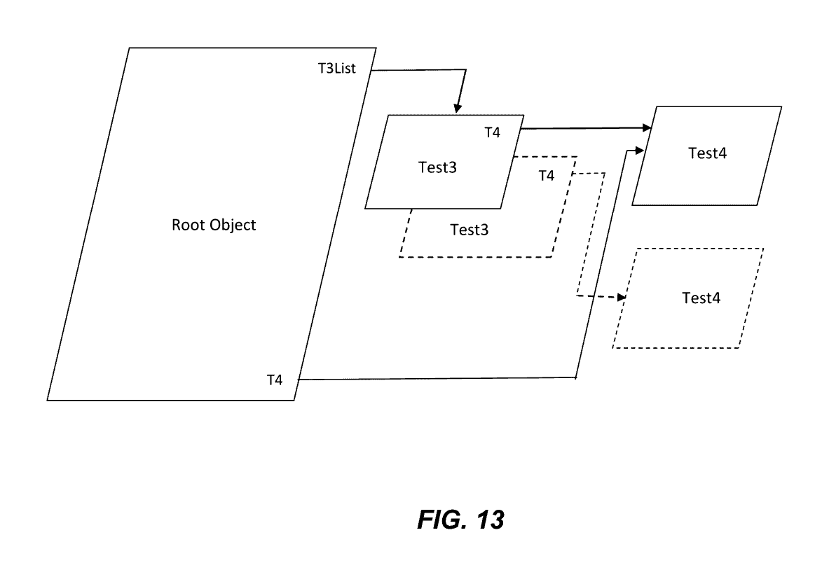

FIG. 12 and FIG. 13 are based on the programs of FIG. 4 and FIG. 5 and are analogous to the conventional memory snapshot windows in FIG. 8 and FIG. 9. FIG. 12 is a 3D memory snapshot that would be shown at the end of the program in FIG. 4. FIG. 12 is very structurally similar to FIG. 10 which illustrates a 3D watch window also made at the end of the program in FIG. 4. This similarity occurs because there are no objects in this memory snapshot that have multiple references in which case a watch window will structurally be the same as a memory snapshot. FIG. 13 illustrates a 3D memory snapshot that would be shown at the end of the program in FIG. 5. In FIG. 13, the objects referenced by property T3List[0].T4 and by the T4 property shown in the watch window are the same. This results in a diagram that is structurally different than FIG. 10 and FIG. 12. Note that in both FIG. 12 and FIG. 13, objects and connections at a lower Z-order in the 3D space are shown with dashed lines.

The present invention can also dynamically show in 3D memory objects as they are created, changed, and destroyed between any two points in time in order to allow the user to visualize better the internal operation of the executing program. In addition, it is possible using visual effects (e.g. coloring) to indicate which objects have been created, changed, and destroyed between any two points in time.

Some embodiments of the present invention may also provide a utility that analyzes the 3D of the memory references for a particular memory snapshot and determines therefrom a “quality score” that indicates how well designed the data structures are. The quality score is based on the routing of the memory reference connections. This analysis takes into account but is not limited to factors such as whether the memory connections overlap, whether they connect objects located at different Z-orders, and the detours the connections make around memory objects. Based solely on routing information, the analysis utility tool can also suggest improvements in the design of the data structures.

The advanced 3D debug window combines the aforementioned 3D watch window and 3D memory profiler into one window. This means that at a breakpoint or call stack method, it is possible to display not only scalar and memory reference variables in 3D space but also any object in memory, and its references to other objects, whether or not its corresponding reference variable is in scope. The memory snapshot can be created at any time, not just at a breakpoint or call stack method.

The system, methods, and computer program products above has been described in general terms as an aid to understanding details of preferred embodiments of the present invention. In the description herein, numerous specific details are provided, such as examples of components and/or methods, to provide a thorough understanding of embodiments of the present invention. Some features and benefits of the present invention are realized in such modes and are not required in every case. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A computer-implemented method for a three-dimensional projection of a set of objects onto a display supporting multiple depths, each object including an X axis, a Y axis, and a Z axis, comprising:
a) presenting a first subset of objects on the display at a first particular display depth, a functional object in said first subset of objects including a mapping element wherein said first subset of objects is selected from the set of objects;
b) detecting a user selection of said mapping element triggering a projection event; and
c) presenting, responsive to said projection event, a second subset of objects on the display at a second particular display depth different from said first particular display depth;
wherein the three-dimensional projection includes a data model including the set of objects, said data model including a set of predetermined relationships between said first subset of objects and said second subset of objects wherein one or more relationships of said set of predetermined relationships are visualized by said presenting step c); and
wherein said second subset of objects is selected from the set of objects;
wherein said data model includes a watch window that is displayed whenever a breakpoint is reached.

2. A computer-implemented method for a three-dimensional projection of a set of objects onto a display supporting multiple depths, each object including an X axis, a Y axis, and a Z axis, comprising:
a) presenting a first subset of objects on the display at a first particular display depth, a functional object in said first subset of objects including a mapping element wherein said first subset of objects is selected from the set of objects;
b) detecting a user selection of said mapping element triggering a projection event; and
c) presenting, responsive to said projection event, a second subset of objects on the display at a second particular display depth different from said first particular display depth;
wherein the three-dimensional projection includes a data model including the set of objects, said data model including a set of predetermined relationships between said first subset of objects and said second subset of objects wherein one or more relationships of said set of predetermined relationships are visualized by said presenting step c); and
wherein said second subset of objects is selected from the set of objects; and
wherein said data model includes a memory snapshot diagram that displays selected objects and a set of memory reference connections amongst said selected objects.

3. The computer-implemented method of claim 2 wherein said memory snapshot uses visual effects to indicate modifications in a memory layout between a set of two points in time.

4. The computer-implemented method of claim 2 wherein said memory snapshot includes a process that provides a data structure design “quality score” responsive to a metric of a routing of a set of memory reference connections.

5. The computer-implemented method of claim 4 wherein said metric includes a complexity of said metric.

6. The computer-implemented method of claim 4 wherein said metric includes a symmetry of said metric.

7. The computer-implemented method of claim 2 wherein said memory snapshot includes a process, responsive to said metric of said routing, suggesting an improved data structure design having a value for said metric.

8. The computer-implemented method of claim 2 wherein said data model includes a watch window that is displayed whenever a breakpoint is reached.

9. The computer-implemented method of claim 8 wherein said watch window includes a 3D watch window.

10. A non-transitory computer-readable medium for a three-dimensional projection of a set of objects onto a display supporting multiple depths, each object including an X axis, a Y axis, and a Z axis, comprising instructions stored thereon, that when executed on at least one processor, perform the steps of:
a) presenting a first subset of objects on the display at a first particular display depth, a functional object in said first subset of objects including a mapping element wherein said first subset of objects is selected from the set of objects;
b) detecting a user selection of said mapping element triggering a projection event; and
c) presenting, responsive to said projection event, a second subset of objects on the display at a second particular display depth different from said first particular display depth;
wherein the three-dimensional projection includes a data model including the set of objects, said data model including a set of predetermined relationships between said first subset of objects and said second subset of objects wherein one or more relationships of said set of predetermined relationships are visualized by said presenting step c); and
wherein said second subset of objects is selected from the set of objects; and
wherein said data model includes a memory snapshot diagram that displays selected objects and a set of memory reference connections amongst said selected objects.

11. The medium of claim 10 wherein said memory snapshot uses visual effects to indicate modifications in a memory layout between a set of two points in time.

12. The medium of claim 10 wherein said memory snapshot includes a process that provides a data structure design “quality score” responsive to a metric of a routing of a set of memory reference connections.

13. The medium of claim 12 wherein said metric includes a complexity of said metric.

14. The medium of claim 12 wherein said metric includes a symmetry of said metric.

15. The medium of claim 10 wherein said memory snapshot includes a process, responsive to said metric of said routing, suggests an improved data structure design having a value for said metric.

16. The medium of claim 10 wherein said data model includes a watch window that is displayed whenever a breakpoint is reached.

17. The medium of claim 16 wherein said watch window includes a 3D watch window.
